(19) United States
(12) Patent Application Publication
(10) Pub. No.: US 2019/0183731 A1
(43) Pub. Date: Jun. 20, 2019

(54) SOLID PHARMACEUTICAL PREPARATION PRINTING METHOD AND SOLID PHARMACEUTICAL PREPARATION PRINTER

(71) Applicant: FREUND CORPORATION, Tokyo (JP)

(72) Inventors: Kiyoshi IMAI, Tokyo (JP); Takerou ADACHI, Tokyo (JP); Takayoshi HOSHINO, Tokyo (JP); Eiichi HACHIYA, Tokyo (JP)

(21) Appl. No.: 16/308,101

(22) PCT Filed: Mar. 13, 2017
(86) PCT No.: PCT/JP2017/009905

§ 371 Date: Dec. 7, 2018

(30) Foreign Application Priority Data
Jun. 13, 2016 (JP) 2016-116863

(51) Int. Cl. A61J 3/00; A61J 3/06; B41J 2/165

(52) U.S. Cl. CPC A61J 3/007; B41J 3/407; B41J 2/165; A61J 3/06

(57) ABSTRACT

A solid pharmaceutical preparation printing method in which printing is performed on successively-supplied solid pharmaceutical preparations by discharging ink from a nozzle of a printing device based on printing data, the printing data including standard printing data and rotated printing data created by rotating the standard printing data at a selected rotation angle, and the printing based on the rotated printing data being performed in addition to the printing based on the standard printing data.

### TECHNICAL FIELD

The present invention relates to a solid pharmaceutical preparation printing method and a solid pharmaceutical preparation printing machine for preventing a nozzle used for applying printing on a solid pharmaceutical preparation from becoming dry and clogged.

### BACKGROUND ART

Solid pharmaceutical preparations such as tablets and capsules may have characters, marks, and the like (which are defined herein as “characters and the like”) printed thereon that clearly indicate the kind or the manufacture of the medicine. An inkjet printer is used for printing such characters and the like. A nozzle of an inkjet printer may become clogged with dried ink when no ink is discharged therefrom for a long time. A clogged nozzle may result in a failure in ink discharge or a decline in the amount of ink discharge in a subsequent discharge of ink from the nozzle.

Patent Literature 1 describes a configuration for preventing a nozzle from becoming clogged, in which the supply drum is temporarily stopped, and the printing device is moved to the right and to the left to discharge ink from another nozzle.

### CITATION LIST

### Patent Literature

Patent Literature 1: Japanese Laid-Open Patent Application Publication No. 2015-186783.

### SUMMARY OF INVENTION

### Technical Problem

However, the configuration described in Patent Literature 1 has a disadvantage in that a drive device is required for moving the printing device and that the operation rate decreases as no printing is possible while the printing head moves.

An object of the present invention is to solve the above-described problem and prevent the clogging of a nozzle without decreasing the operation rate.

### Solution to Problem

In order to solve the above-described problem, the present invention provides a solid pharmaceutical preparation printing method of performing printing on freely rotatable solid pharmaceutical preparations, which are successively supplied, by discharging ink from a nozzle of a printing device, based on print data sets, wherein the print data sets include a standard print data set and a rotated print data set created by rotating the standard print data set at a freely selected rotation angle and wherein printing based on the rotated print data set is performed in addition to printing based on the standard print data set.

This configuration improves the discharge rates of the nozzles without moving the printing device and prevents the clogging of a nozzle without decreasing the operation rate.

The method may be configured in such a way that the print data sets include the standard print data set and a plurality of rotated print data sets having different rotation angles, wherein printing is performed by equally using the standard print data set and the plurality of the rotated print data sets in order of the rotation angle or in reverse order of the rotation angle.

This configuration improves the discharge rates of the nozzles equally without moving the printing device and prevents the clogging of a nozzle without decreasing the operation rate.

The method may be configured in such a way as to further performing, with an inspection device, print inspection on characters and the like printed on each solid pharmaceutical preparation by the printing device, wherein the inspection device performs inspection by comparing the standard print data set or the rotated print data set used for the printing on the solid pharmaceutical preparation with the characters and the like printed on the solid pharmaceutical preparation.

This configuration allows a print inspection to be performed appropriately.

In order to solve the above-described problem, the present invention further provides a solid pharmaceutical preparation printing machine that performs printing on freely rotatable solid pharmaceutical preparations, which are successively supplied, by discharging ink from a nozzle of a printing device, based on print data sets, wherein the print data sets include a standard print data set and a rotated print data set created by rotating the standard print data set at a freely selected rotation angle and wherein the printing device performs printing based on the rotated print data set in addition to printing based on the standard print data set.

This configuration improves the discharge rates of the nozzles without moving the printing device and prevents the clogging of a nozzle without decreasing the operation rate.

The machine may be configured in such a way that the print data sets include the standard print data set and a plurality of the rotated print data sets having different rotation angles, wherein the machine further includes a control device that performs control in such a way that printing is performed by equally using the standard print data set and the plurality of the rotated print data sets in order of the rotation angle or in reverse order of the rotation angle.

This configuration improves the discharge rates of the nozzles equally without moving the printing device and prevents the clogging of a nozzle without decreasing the operation rate.

The machine may be configured in such a way as to further include an inspection device that performs inspection on characters and the like printed on each solid pharmaceutical preparation by the printing device, wherein the inspection device performs inspection by comparing the standard print data set or the rotated print data set used for the printing on the solid pharmaceutical preparation with the characters and the like printed on the solid pharmaceutical preparation.

This configuration allows a print inspection to be performed appropriately.

### BRIEF DESCRIPTION OF DRAWINGS

FIG. 1 is a diagram for illustrating a configuration of a solid pharmaceutical preparation printing machine according to Embodiment 1 of the present invention.

FIG. 2 is a diagram for illustrating a printing device portion of the solid pharmaceutical preparation printing machine according to Embodiment 1 of the present invention.

FIG. 3 is a diagram for illustrating an example of nozzles and characters and the like when a standard print data set is used according to the Embodiment 1 of the present invention.

FIG. 4 is a diagram for illustrating an example of nozzles and characters and the like when a rotated print data set at a rotation angle of 90° is used according to Embodiment 1 of the present invention.

FIG. 5 is a diagram for illustrating an example of print data sets according to Embodiment 2 of the present invention.

### DESCRIPTION OF EMBODIMENTS

### Embodiment 1

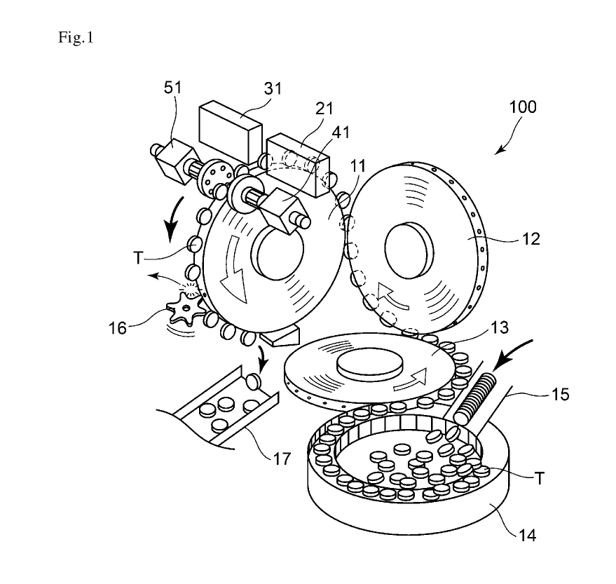

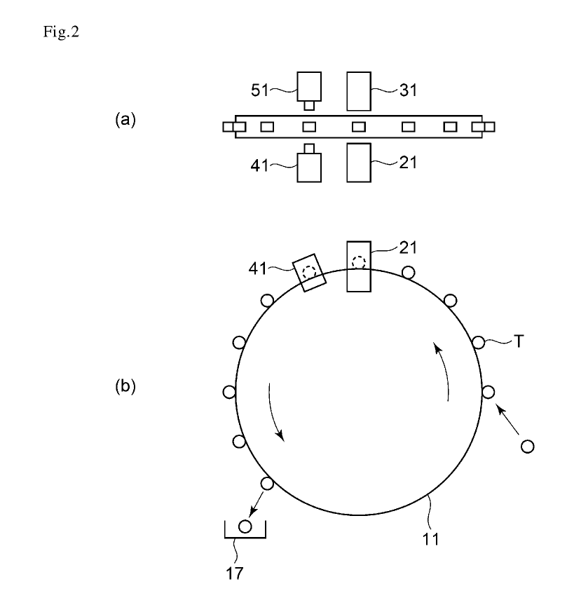

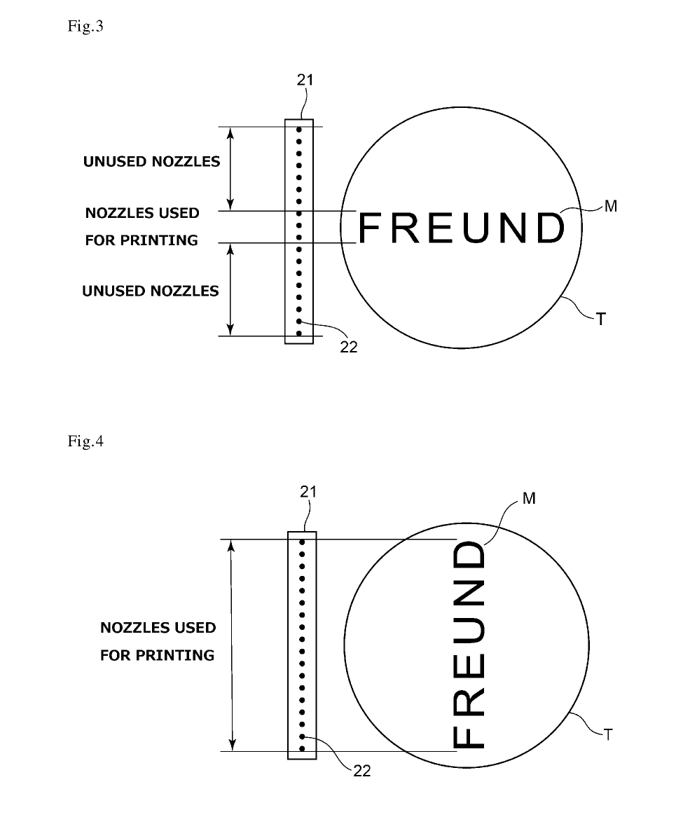

Embodiment 1 of the present invention will be described below with reference to FIGS. 1 to 4. FIG. 1 is a diagram for illustrating a configuration of a solid pharmaceutical preparation printing machine according to Embodiment 1 of the present invention. FIG. 2(a) is a top view for illustrating a printing device portion of the solid pharmaceutical preparation printing machine according to Embodiment 1 of the present invention. FIG. 2(b) is a front view for illustrating the printing device portion of the solid pharmaceutical preparation printing machine according to Embodiment 1 of the present invention. FIG. 3 is a diagram for illustrating an example of nozzles and characters and the like when a standard print data set is used according to the Embodiment 1 of the present invention. FIG. 4 is a diagram for illustrating an example of nozzles and characters and the like when a rotated print data set at a rotation angle of 90° is used according to the Embodiment 1 of the present invention.

Herein, a solid pharmaceutical preparation in the present invention means a tablet or a medicine in a spherical shape. Further, a freely rotatable solid pharmaceutical preparation in the present invention means a solid pharmaceutical preparation without a splitting line, on which characters and the like can be printed irrespective of what rotational angle it is rotated at.

As illustrated in FIG. 1, a solid pharmaceutical preparation printing machine 100 according to Embodiment 1 of the present invention includes a disk 11, a disk 12, a disk 13, a parts feeder 14, a solid pharmaceutical preparation feeding unit 15, a defectives removing unit 16, a printing device 21, an image capturing device 41, a printing device 31, an image capturing device 51, a storage box 17, and the like. The disk 11 is arranged with the main surface thereof disposed vertically and the disk 12 is arranged vertically and perpendicularly to the disk 11 with the side surfaces of the disk 11 and the disk 12 close to each other. The disk 13 is arranged horizontally and perpendicularly to the disk 12 with the side surfaces of the disk 12 and the disk 13 close to each other. The disk 11, the disk 12, and the disk 13 have a plurality of suction holes on their circumferential side surfaces and are capable of drawing and holding by suction solid pharmaceutical preparations T onto their suction holes.

When the solid pharmaceutical preparations T are fed from the solid pharmaceutical preparation feeding unit 15 to the parts feeder 14, the solid pharmaceutical preparations T are gradually lined up in the horizontal direction by the vibration or rotation of the parts feeder 14. At a final extremity of the parts feeder 14, each of the solid pharmaceutical preparations T so lined up is drawn by suction onto a suction hole provided on the circumferential side surface of the disk 13, the side surface of the solid pharmaceutical preparations T being attached onto the suction hole. As the disk 13 rotates counterclockwise, the solid pharmaceutical preparation T held by suction onto the suction hole on the circumferential side surface of the disk 13 is carried in a circular horizontal movement toward the disk 12. When the solid pharmaceutical preparation T comes close to the disk 12, the suction from a suction hole of the disk 12 close to the solid pharmaceutical preparation T is started while the suction from the suction hole of the disk 13 is halted and a first surface of the solid pharmaceutical preparation T is drawn by suction onto the suction hole of the disk 12. The disk 12 rotates clockwise to carry the solid pharmaceutical preparation T held by suction thereon in a circular vertical movement toward the disk 11. When the solid pharmaceutical preparation T comes close to the disk 11, the suction from a suction hole of the disk 11 close to the solid pharmaceutical preparation T is started while the suction from the suction hole of the disk 12 is halted and the side surface of the solid pharmaceutical preparation T is held by suction onto the suction hole of the disk 11. As the disk 11 rotates, the solid pharmaceutical preparation T held by suction onto the disk 11 is carried in a counterclockwise circular vertical movement.

Next, the printing and the print inspection on the solid pharmaceutical preparations T drawn by suction onto the disk 11 will be described in detail with reference to FIG. 1 and FIG. 2. The disk 11 receives from the disk 12 a vertically positioned solid pharmaceutical preparation T at the initial extremity in the direction of rotation at the side of the disk 11 by drawing by suction the side surface of the solid pharmaceutical preparation T and holds the solid pharmaceutical preparation T by suction, with a first surface of the solid pharmaceutical preparation T faced to the front and a second surface of the solid pharmaceutical preparation T faced to the back. As the disk 11 rotates counterclockwise, the solid pharmaceutical preparations T held by suction are consecutively carried in a counterclockwise circular movement. When a solid pharmaceutical preparation T is brought by the circular movement to a position at which the printing device 21 and the printing device 31 can apply printing, the solid pharmaceutical preparation T is detected by a sensor (not illustrated) and the printing device 21 prints characters and the like on the first surface of the solid pharmaceutical preparation T and the printing device 31 prints characters and the like on the second surface of the solid pharmaceutical preparation T. The printing device 21 and the printing device 31 are each constituted by an inkjet printer and apply printing by discharging ink from a plurality of nozzles 22 (see FIG. 3) disposed in a line approximately perpendicular to the direction of the circular movement of the solid pharmaceutical preparation T.

Note that the nozzles of the printing device 21 and the printing device 31 need not be line up in one line and may be lined in a plurality of lines. Further, the printing device 21 and the printing device 31 are not limited to inkjet printers but need only to be configured to discharge ink from nozzles.

The printing device 21 and the printing device 31 are both connected to a print data set storage device (not illustrated). Print data sets are stored in the print data set storage device in advance and printing is performed based on the print data sets. Further, the print data set storage device is connected to a control device (not illustrated) and the control device controls the print data set storage device, the printing device 21, and the printing device 31, selecting a print data set to be used from among the print data sets stored in the print data set storage device for each printing operation.

As the disk 11 further rotates counterclockwise, the image capturing device 41 captures an image of the first surface and the image capturing device 51 captures an image of the second surface of the solid pharmaceutical preparation T to which the printing is applied. The images captured by the image capturing device 41 and the image capturing device 51 are inspected by an inspection device (not illustrated) with respect to the characters and the like printed on each surface. At this time, the inspection device performs the inspection by receiving the print data set (standard print data set or rotated print data set to be described later) used for the printing of the characters and the like on the solid pharmaceutical preparation T and by comparing the print data set used for the printing on the solid pharmaceutical preparation T with the characters and the like actually printed. This allows the inspection to be performed appropriately. The solid pharmaceutical preparations T rated as defective as the result of the print inspection are removed by the defectives removing unit 16 and the solid pharmaceutical preparations T rated as satisfactory are stored in the storage box 17 in the vicinity of the extremity in the direction of rotation of the disk 11.

Note that, although the image capturing device 41 and the image capturing device 51 capture the images of the surfaces of the solid pharmaceutical preparations T and the inspection device performs print inspection in Embodiment 1, the configuration is not limited thereto and may be altered as appropriate to fit the requirements of the solid pharmaceutical preparation printing machine. For example, the print inspection may be omitted for one of the surfaces or for both surfaces, the image capturing device 41 and/or the image capturing device 51 being removed, and appearance inspection on the solid pharmaceutical preparation T may be performed before printing. Further, appearance inspection may be performed by capturing an image of the side surface of the solid pharmaceutical preparation T by the image capturing device while the first surface of the solid pharmaceutical preparation T is drawn by suction onto the disk 12.

As print data sets, a standard print data set and a rotated print data set are stored in the print data set storage device in advance. The rotated print data set can be easily created with image processing software by rotating the standard print data set at a freely selected rotation angle. The standard print data set may be created by capturing an image of a standard sample of the solid pharmaceutical preparations T or may be created manually in a bitmap format. The characters and the like M in FIG. 3 illustrate an example of a printing using a print data set rotated at a rotation angle of 0° as the standard print data set and the characters and the like M illustrated in FIG. 4 illustrate an example of a printing using rotated print data set created by rotating the standard print data set by 90°.

Note that, although the print data set storage device stores rotated print data sets in advance in Embodiment 1, the configuration is not necessarily limited thereto and may be altered as appropriate to fit the requirements of the solid pharmaceutical preparation printing machine. For example, the print data set storage device may store only the standard print data set, not storing any rotated print data set, and a rotated print data set may be created on each printing operation.

Next, an operation of printing will be described in detail. The printing device 21 and the printing device 31 perform printing in a similar way and the printing device 21 will be described as an example. Usually, as illustrated in FIG. 3, the control device controls the print data set storage device and the printing device 21 to perform printing on the solid pharmaceutical preparations T by using the standard print data set at a rotation angle of 0°. Under the control by the control device, the printing device 21 discharges ink from nozzles 22 and prints characters and the like M, for example, “FREUND”. At this time, since the solid pharmaceutical preparations T such as tablets, pills, or the like without a splitting line are freely rotatable, it is possible to print with the standard print data set irrespective of the rotation of each solid pharmaceutical preparation T as illustrated in FIG. 3. The nozzles 22 used at this time are only a few nozzles 22 located in the middle part of the printing device 21. As such, when the printing is continued solely with the standard print data set at a rotation angle of 0°, the printing can be performed with a simple configuration, but the nozzles not located in the middle part of the printing device 21 are not used and discharge no ink and such nozzles 22 may get clogged with dried ink. In such a case, when printing is performed with a different print data set from “FREUND” and nozzles 22 not used for printing “FREUND” are used, ink may not be discharged smoothly or not discharged at all.

To address this, a processing called purging or spitting, in which ink is discharged from all the nozzles 22 of the printing device 21, is executed regularly or depending on the printing conditions to prevent the ink from drying. However, this processing consumes expensive ink in a large amount and results in a wasteful use of ink (it is said that 80% of the ink is used in this processing).

Therefore, in Embodiment 1, the printing on the freely rotatable solid pharmaceutical preparations T is performed with a rotated print data set in addition to the printing based on the standard print data set to prevent the clogging of the inkjet nozzles. The rotated print data set is a print data set created by rotating the standard print data set around a rotation axis at the center thereof or at a freely selected position at a freely selected rotation angle. FIG. 4 illustrates the relation between the nozzles 22 of the printing device 21 and the characters and the like M printed on a solid pharmaceutical preparation T when such a rotated print data set is used for the printing.

FIG. 4 illustrates an example of a printing with a rotated print data set created by rotating the standard print data set at a rotation angle of 90°. By printing with the rotated print data set at a rotation angle 90°, ink is discharged from many of the nozzles 22 of the printing device 21. Thus, it is possible to discharge ink from may nozzles 22 by printing based on the rotated print data set in addition to printing based on the standard print data set and hence to prevent ink from drying in many nozzles 22 and to prevent clogging.

Herein, the standard print data set has been described as a print data set at a rotation angle of 0° but is not necessarily limited thereto and may be altered in accordance with the requirements of the solid pharmaceutical preparations and the characters and the like to be printed. For example, a print data set at a rotation angle of 5° may be used as the standard print data set and a print data set at a rotation angle of 85° may be used as the standard print data set.

Further, the rotated print data set has been described as a print data set at a rotation angle of 90° but is not necessarily limited thereto and may be altered in accordance with the requirements of the solid pharmaceutical preparations and the characters and the like to be printed. For example, a print data set at a rotation angle of 30° may be used as the rotated print data set and a print data set at a rotation angle of 125° may be used as the rotated print data set.

The frequency of the printing based on the rotated print data set may be determined as appropriate in accordance with the dryness of the ink in the nozzles 22 and requirements of the control. For example, printing may usually be performed based on the standard print data set and, measuring the dryness of the ink, printing may be performed based on the rotated print data set depending on the results of the measurement. Alternatively, printing may be performed without measuring the dryness of the ink, by performing control to equalize the frequencies of use of the nozzles.

A print inspection is performed after the printing of the characters and the like on a solid pharmaceutical preparation T. This inspection is performed by comparing the print data set used for the printing on the solid pharmaceutical preparation T, i.e., the standard print data set or the rotated print data set with the printed characters and the like. In other words, when the printing on the solid pharmaceutical preparation T is based on the standard print data set, the standard print data set and the printed characters and the like are compared to check for a dropout, slurring, or faulty registration. When the printing on the solid pharmaceutical preparation T is based on the rotated print data set, the rotated print data set and the printed characters and the like are compared to check for a dropout, slurring, or faulty registration.

Note that, although solid pharmaceutical preparations are supplied to the printing devices by the disks in Embodiment 1, the configuration is not necessarily limited thereto and need only to supply solid pharmaceutical preparations to the printing devices without shifting the positions of the solid pharmaceutical preparations and the configuration may be altered as appropriate in accordance with the requirements of the solid pharmaceutical preparation printing machine. For example, the solid pharmaceutical preparations may be supplied by a drum or a magazine. Further, when a conveyer is used to convey the solid pharmaceutical preparations, the positions of the solid pharmaceutical preparations may shift by the time when the solid pharmaceutical preparations are supplied to the printing devices, and the printing position may be corrected by a position recognition technique using a camera.

As described above, since the printing is performed on solid pharmaceutical preparations based on a standard print data set and a rotated print data set in the Embodiment 1 of the present invention, the clogging of the nozzles is prevented without halting the printing operation. As ink is discharged from other nozzles, the printing device 21 and the printing device 31 need not be moved and the clogging of the nozzles can be prevented without the need for a driving mechanism or other components.

As described above, in Embodiment 1, the discharge rates of the nozzles are improved without moving any printing device and the clogging of a nozzle is thereby prevented without decreasing the operation rate owing to a solid pharmaceutical preparation printing method of performing printing on freely rotatable solid pharmaceutical preparations, which are successively supplied, by discharging ink from a nozzle of a printing device, based on print data sets, wherein the print data sets include a standard print data set and a rotated print data set created by rotating the standard print data set at a freely selected rotation angle and wherein printing based on the rotated print data set is performed in addition to printing based on the standard print data set.

Further, the discharge rates of the nozzles are improved without moving any printing device and the clogging of a nozzle is thereby prevented without decreasing the operation rate owing to a solid pharmaceutical preparation printing machine that performs printing on freely rotatable solid pharmaceutical preparations, which are successively supplied, by discharging ink from a nozzle of a printing device, based on print data sets, wherein the print data sets include a standard print data set and a rotated print data set created by rotating the standard print data set at a freely selected rotation angle and wherein the printing device performs printing based on the rotated print data set in addition to printing based on the standard print data set.

### Embodiment 2

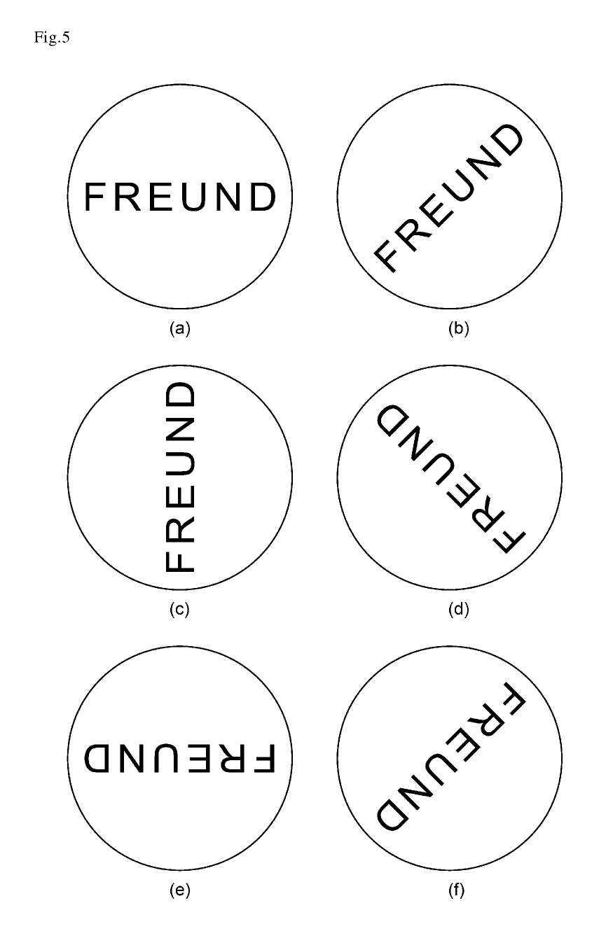

Embodiment 2 of the present invention employs print data sets including a standard print data set and a plurality of rotated print data set having different rotation angles and differs from Embodiment 1 in that printing is performed by equally using the standard print data set and the plurality of rotated print data sets in order of the rotation angle or in reverse order of the rotation angle. Embodiment 2 of the present invention will be described with reference to FIG. 5. FIG. 5 is a diagram for illustrating an example of print data sets according to Embodiment 2 of the present invention.

First, a plurality of rotated print data sets are created by rotating the standard print data set around a rotation axis at the center thereof or at a freely selected position at freely selected different rotation angles and are stored in a print data set storage device (not illustrated) together with the standard print data set. FIG. 5(a) illustrates a standard print data set, FIG. 5 (b) illustrates a rotated print data set created by rotating the standard print data set at 45°, FIG. 5(c) illustrates a rotated print data set created by rotating the standard print data set at 90°, FIG. 5(d) illustrates a rotated print data set created by rotating the standard print data set at 135°, FIG. 5(e) illustrates a rotated print data set created by rotating the standard print data set at 180°, and FIG. 5(f) illustrates a rotated print data set created by rotating the standard print data set at 225°.

The rotated print data sets created by rotating the standard print data set at the rotation angles can easily be created with image processing software. The standard print data set may be created by capturing an image of a standard sample of the solid pharmaceutical preparations T or may be created manually in a bitmap format.

The solid pharmaceutical preparations T fed to the parts feeder 14 by the solid pharmaceutical preparation feeding unit 15 are conveyed, by way of the disk 13 and the disk 12, to the disk 11 and conveyed in a circular movement, the sides of the solid pharmaceutical preparations T held by suction onto the disk 11. Printing is successively applied to the solid pharmaceutical preparations T successively fed to the printing device 21 and the printing device 31, based on the standard print data set and the plurality of rotated print data sets stored in the above-described print data set storage device. In Embodiment 2, control is performed in such a way as to discharge ink from as many nozzles 22 as possible by using the print data sets equally.

In order to do so, in Embodiment 2, a control device (not illustrated) is provided and control is performed to perform printing using the standard print data set and the plurality of rotated print data sets stored in the print data set storage device (not illustrated), in order of the rotation angle or in reverse order of the rotation angle. In other words, in Embodiment 2, printing is performed by equally using the print data sets in order of the rotation angle, for example, the standard print data set at a rotation angle of 0°, then the rotated print data set rotated at a rotation angle of 45°, then the rotated print data set rotated at a rotation angle of 90°, then the rotated print data set rotated at a rotation angle of 135°, then the rotated print data set rotated at a rotation angle of 180°, and lastly, the rotated print data set rotated at a rotation angle of 225°. After that, starting again with the standard print data set at a rotation angle of 0°, the print data sets are used in order of the rotation angle as described above and lastly the rotated print data set rotated at a rotation angle of 225° is used.

Alternatively, printing is applied to the solid pharmaceutical preparations T by using the print data sets in reverse order of the rotation angle, instead of the rotation angle. In other words, in the case of the example in FIG. 5, printing is performed by equally using the print data sets in reverse order of the rotation angle, for example, first of all, the rotated print data set rotated at a rotation angle of 225°, then the rotated print data set rotated at a rotation angle of 180°, then the rotated print data set rotated at a rotation angle of 135°, then the rotated print data set rotated at a rotation angle of 90°, then the rotated print data set rotated at a rotation angle of 45°, and lastly the standard print data set at a rotation angle of 0°. Printing is performed further repeating the use of the print data sets in reverse order of rotation angle.

Thus, by using the print data sets in order of the rotation angle or in reverse order of the rotation angle, the discharge rates of the inkjet nozzles can be improved equally. Further, as printing is applied to the solid pharmaceutical preparations using a standard print data set and a plurality of rotated print data sets, the clogging of the nozzles can be prevented without halting the printing operation. Further, as the printing devices need not be moved to prevent the cogging of a nozzle, there is no need for a driving mechanism and the clogging of a nozzle can be prevented without decreasing the operation rate.

A print inspection is performed after the printing of the characters and the like on each solid pharmaceutical preparations T with an inspection device (not illustrated) by capturing an image of each surface of the solid pharmaceutical preparation T using the image capturing device 41 and the image capturing device 51. This inspection is performed by comparing the print data set used for the printing on the solid pharmaceutical preparation T, i.e., the standard print data set or one of the rotated print data sets with the printed characters and the like. In other words, when the printing on the solid pharmaceutical preparation T is based on the standard print data set, the standard print data set and the printed characters and the like are compared to check for a dropout, slurring, or faulty registration. When the printing on the solid pharmaceutical preparation T is based on one of the rotated print data set, the rotated print data set used and the printed characters and the like are compared to check for a dropout, slurring, or faulty registration.

Note that, although the print data set storage device stores the plurality of rotated print data sets in advance in Embodiment 2, the configuration is not necessarily limited thereto and may be altered as appropriate in accordance with the requirements for the solid pharmaceutical preparation printing machine. For example, the print data set storage device may store only the standard print data set, not storing any of the rotated print data sets, and rotated print data sets may be created in order of the rotation angle or in reverse order of the rotation angle on each printing operation.

### INDUSTRIAL APPLICABILITY

A solid pharmaceutical preparation printing method and a solid pharmaceutical preparation printing machine according to the present invention can be applied widely in the area of printing on a solid pharmaceutical preparation using a printing device that discharges ink.

### REFERENCE SIGNS LIST

11 disk
12 disk
13 disk
14 parts feeder
15 solid pharmaceutical preparation feeding unit
16 defectives removing unit
17 storage box
21 printing device
22 nozzle
31 printing device
41 image capturing device
51 image capturing device
100 solid pharmaceutical preparation printing machine
M characters and the like
T solid pharmaceutical preparation

1. A solid pharmaceutical preparation printing method of performing printing on freely rotatable solid pharmaceutical preparations, which are successively supplied, by discharging ink from a nozzle of a printing device, based on print data sets,
wherein the print data sets comprise a standard print data set and a rotated print data set created by rotating the standard print data set at a freely selected rotation angle, and
wherein printing based on the rotated print data set is performed in addition to printing based on the standard print data set.

2. The solid pharmaceutical preparation printing method according to claim 1,
wherein the print data sets comprise the standard print data set and a plurality of the rotated print data sets having different rotation angles and
wherein printing is performed by equally using the standard print data set and the plurality of the rotated print data sets in order of the rotation angle or in reverse order of the rotation angle.

3. The solid pharmaceutical preparation printing method according to claim 1, further comprising performing, with an inspection device, print inspection on characters and the like printed on each solid pharmaceutical preparation by the printing device,
wherein the inspection device performs inspection by comparing the standard print data set or the rotated print data set used for the printing on the solid pharmaceutical preparation with the characters and the like printed on the solid pharmaceutical preparation.

4. A solid pharmaceutical preparation printing machine that performs printing on freely rotatable solid pharmaceutical preparations, which are successively supplied, by discharging ink from a nozzle of a printing device, based on print data sets,
wherein the print data sets comprise a standard print data set and a rotated print data set created by rotating the standard print data set at a freely selected rotation angle, and
wherein the printing device performs printing based on the rotated print data set in addition to printing based on the standard print data set.

5. The solid pharmaceutical preparation printing machine according to claim 4,
wherein the print data sets comprise the standard print data set and a plurality of the rotated print data sets having different rotation angles, and
wherein the machine further comprises a control device that performs control in such a way that printing is performed by equally using the standard print data set and the plurality of the rotated print data sets in order of the rotation angle or in reverse order of the rotation angle.

6. The solid pharmaceutical preparation printing machine according to claim 4, further comprising an inspection device that performs inspection on characters and the like printed on each solid pharmaceutical preparation by the printing device,
wherein the inspection device performs inspection by comparing the standard print data set or the rotated print data set used for the printing on the solid pharmaceutical preparation with the characters and the like printed on the solid pharmaceutical preparation.

7. The solid pharmaceutical preparation printing method according to claim 2, further comprising performing, with an inspection device, print inspection on characters and the like printed on each solid pharmaceutical preparation by the printing device,
wherein the inspection device performs inspection by comparing the standard print data set or the rotated print data set used for the printing on the solid pharmaceutical preparation with the characters and the like printed on the solid pharmaceutical preparation.

8. The solid pharmaceutical preparation printing machine according to claim 5, further comprising an inspection device that performs inspection on characters and the like printed on each solid pharmaceutical preparation by the printing device,
wherein the inspection device performs inspection by comparing the standard print data set or the rotated print data set used for the printing on the solid pharmaceutical preparation with the characters and the like printed on the solid pharmaceutical preparation.
